(19) United States
(12) Patent Application Publication
(10) Pub. No.: US 2026/0260468 A1
(43) Pub. Date: Sep. 3, 2026

(54) DISTRIBUTED ITEM TRAINING FOR VISON-BASED ITEM RECOGNITION

(71) Applicant: NCR Voyix Corporation, Atlanta, GA (US)

(72) Inventors: Gina Torcivia Bennett, Lawrenceville, GA (US); Kip Oliver Morgan, Atlanta, GA (US); WuChieh James Jong, Raleigh, NC (US); Timothy Edward Mason, Flowery Branch, GA (US)

(21) Appl. No.: 19/067,268

(22) Filed: Feb. 28, 2025

(51) Int. Cl. G06V 10/774; G06T 7/20; G06T 7/70; G06V 10/26; G06V 10/776; G06V 10/98; G07G 1/00; H04N 23/60

(52) U.S. Cl. CPC G06V 10/774; G06T 7/20; G06T 7/70; G06V 10/273; G06V 10/776; G06V 10/993; G07G 1/0054; H04N 23/64

(57) ABSTRACT

A system and method for distributed collection of item training data for vision-based checkout systems using point-of-sale terminals and self-service terminals during idle periods. The system enables store personnel to capture multiple item images from different angles and positions through an intuitive interface that supports suspend and resume capabilities across different terminals. The system includes automated image enhancement, centralized data collection, and integrated quality metrics to improve vision recognition accuracy. This approach leverages existing hardware while improving worker productivity and enabling enterprise-wide sharing of item training data.

### BACKGROUND

Vision-based checkout systems that recognize items by their visual properties rather than scanning barcodes represent the next evolution in self-checkout technology. However, these systems face significant challenges in maintaining accurate item recognition over time. Item packaging frequently changes, requiring retraining of the vision system. New items are constantly being added to store catalogs, leading to unrecognized products. The initial training data may be insufficient for reliable recognition. Current approaches typically require dedicated training terminals with specialized software and hardware, making the training process inefficient and store specific. Additionally, the creation of product images for display during transactions is often a manual, error-prone process.

### BRIEF DESCRIPTION OF THE DRAWINGS

FIG. 1A is a diagram of a system for distributed item training for vision-based item recognition, according to an example embodiment.

FIG. 1B is a flow diagram of a method for operating the system of FIG. 1A, according to an embodiment.

FIG. 1C is a diagram of a terminal display and screen for an item training interface, according to an example embodiment.

FIG. 1D is a diagram of the terminal display and another screen for the item training interface, according to an example embodiment.

FIG. 1E is a diagram illustrating use of an item stabilizing widget with an item during item image capture, according to an example embodiment.

FIG. 2 is a flow diagram of a method for distributed item training for vision-based item recognition, according to an example embodiment.

FIG. 3 is a flow diagram of another method for distributed item training for vision-based item recognition, according to an example embodiment.

### DETAILED DESCRIPTION

Vision checkout systems that identify items through visual properties rather than barcode scanning represent a significant advancement in retail technology. However, these systems face multiple operational challenges that impact their effectiveness and reliability. The initial excitement of vision-based checkout often diminishes as the system struggles to keep pace with constantly changing item catalogs and packaging variations. The training of items for vision recognition is traditionally performed at dedicated terminals with specialized equipment, creating a bottleneck in the process and limiting the ability to quickly adapt to new or modified products.

The conventional approach to item training is particularly problematic as it requires dedicated resources and creates store-specific silos of training data. The process of bulk training items is tedious and time-consuming. When items are trained using different barcode scanners, inconsistencies can arise due to varying scanner programming. Additionally, the creation of menu and sales images suitable for on-screen display during transactions typically requires manual intervention, leading to potential errors and inconsistencies. The ambient lighting conditions at dedicated training stations may differ from actual checkout lanes, affecting recognition accuracy.

In an embodiment presented herein, the methods and system enable store personnel to collect training images and data using existing point-of-sale (POS) terminals and self-service terminals (SSTs) during periods when they would otherwise be idle. A shared device service allows multiple applications to utilize a universal product code (UPC) barcode scanner through enhanced logic built on top of standard object linking and embedding for POS (OPOS) terminals or JavaPOS® (JPOS) services. The user interface provides intuitive guidance for capturing multiple images of items from different angles and positions, with visual indicators showing proper item placement.

In an embodiment presented herein, the methods and system incorporate a suspend/resume capability that allows attendants to pause item training when customers need assistance and resume the session later, potentially on a different terminal and/or by a completely different attendant. The methods and system track progress and maintain training logs showing completion status for each item. A specialized stabilizing widget prevents items from moving during image capture, while automated image enhancement software removes backgrounds to create clean product images. These enhanced images serve multiple purposes, including catalog updates and transaction interfaces. The captured data is centralized and can be shared across an enterprise's stores, while maintaining proper attribution for copyright compliance for model icon images of items presented with item details during checkouts on displays of the terminals.

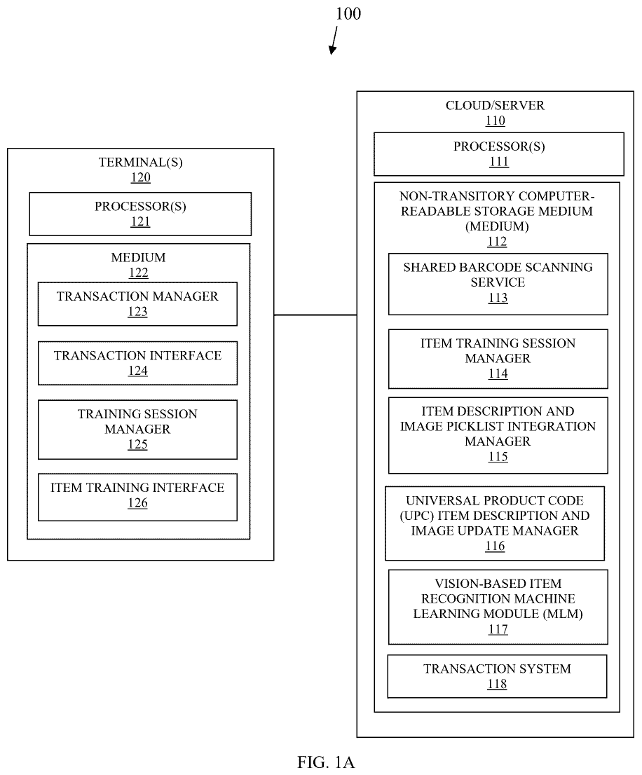

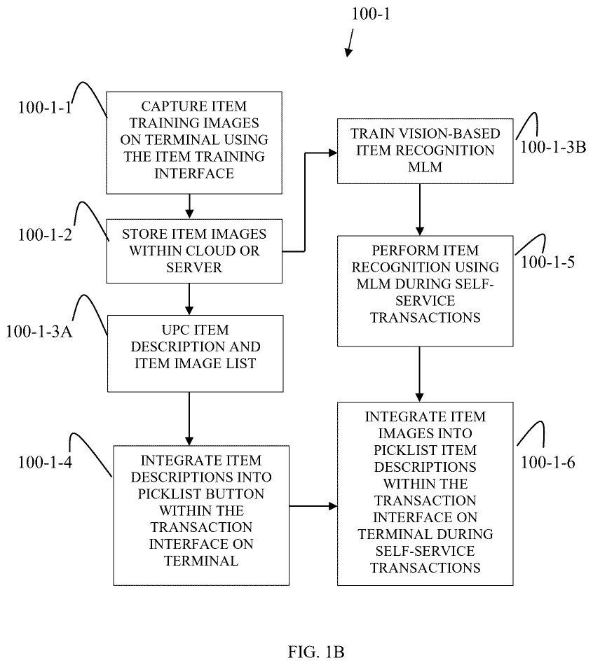

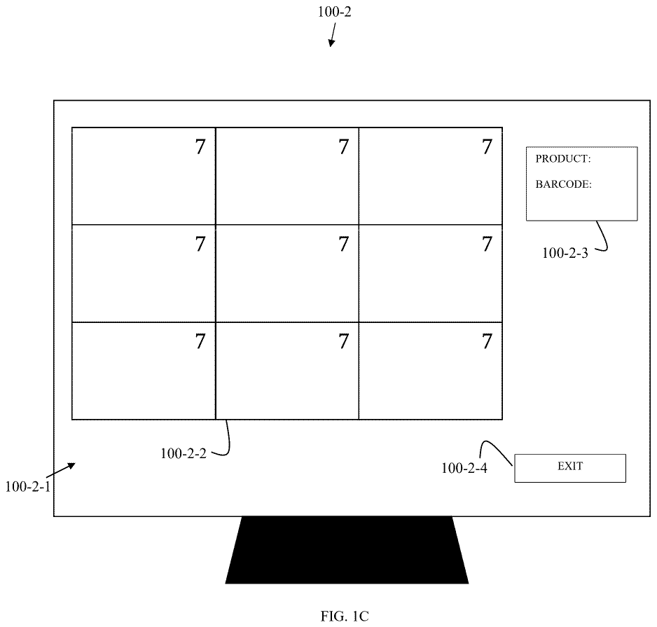

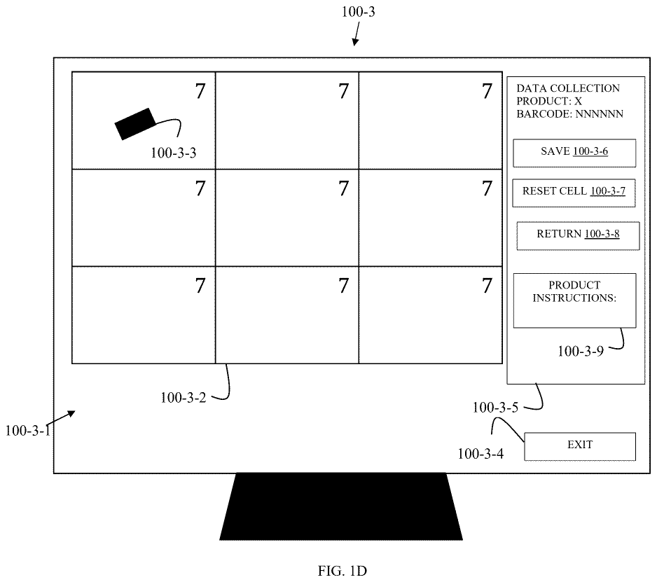

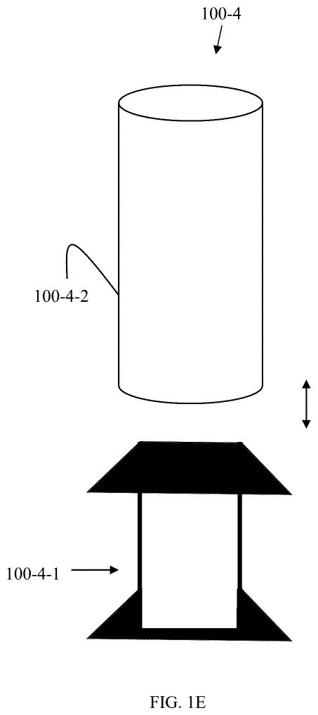

FIG. 1A is a diagram of a system 100 for distributed item training for vision-based item recognition, according to an example embodiment. Notably, the components are shown schematically in greatly simplified form, with only those components relevant to understanding of the embodiments being illustrated.

Furthermore, the various components (that are identified in system 100) are illustrated and the arrangement of the components are presented for purposes of illustration only. It is to be noted that other arrangements with more or less components are possible without departing from the teachings of distributed item training for vision-based item recognition, presented herein and below.

System 100 includes a cloud 110 and multiple transaction terminals 120. In an embodiment, the transaction terminals 120 include POS terminals and/or SSTs. In an embodiment, one or more of the terminals may be located in different stores of a retail chain.

The cloud 110 or server includes a processor 111 and a non-transitory computer-readable storage medium (medium), which include instructions for a shared barcode scanning service 113, an item training session manager 114, an item description and image picklist integration manager 115, a UPC item description and image update manager 116, a vision-based item recognition machine learning model (MLM) 117, and a transaction system 118. The instructions when executed by the processor 111 cause the processor 111 to perform operations discussed herein and below with respect to 113-118.

Each terminal 120 includes at least one processor 121 and a medium 122, which includes instructions for a transaction manager 123, a transaction interface 124, a transaction session manager 125, and an item training interface 126. The instructions when executed by the processor 121 cause the processor 121 to perform the operations discussed herein and below with respect to 123-126.

The shared barcode scanning service 113 provides enhanced logic on top of standard OPOS or JPOS services that enables multiple applications executing on terminal(s) 120 to share and access the terminal's barcode scanner. The service 113 manages claiming and releasing of the scanner by different applications.

The item training session manager 114 coordinates item training sessions across multiple terminals 120, tracking progress of image captures and maintaining session state when sessions are suspended and resumed. The item training session manager 114 maintains training logs showing completion status for each item training session and which attendant last worked on capturing images for an item. The item training session manager 114 also maintains metrics relevant to item recognition accuracy and training session completion, including how many times a given item was unrecognized by vision recognition, time required to accurately train new items, and number of item training sessions completed by particular attendants.

The item description and image picklist integration manager 115 creates and updates self-checkout menu buttons using processed item images. The manager 115 integrates these buttons into suggestion options displayed during self-checkout transactions when the MLM 117 cannot definitively distinguish between visually similar items.

The UPC item description and image update manager 116 processes captured menu images of items to remove backgrounds through color keying techniques. The UPC item description and image update manager 116 maintains proper attribution of processed images by adding store identification attributes for copyright compliance. The processed images are used for catalog displays and the transaction interface 124. The UPC item description and image update manager 116 applies grey, green, or white background removal techniques to generate clean product images with consistent backgrounds for optimal visual recognition.

The vision-based item recognition MLM 117 is trained using the captured and processed item images to perform visual identification of items during checkout transactions. The MLM 117 leverages training data collected across multiple stores and multiple terminals 120 in a retail chain to improve item recognition accuracy.

In an embodiment, the MLM 117 is trained on the captured and processed item images from the terminals 120 of different stores associated with multiple item training sessions. Each store's actual lighting conditions are reflected in the captured and processed images. Furthermore, images to train the MLM 117 on a particular item may be associated with an item training session associated with one or more first terminals 120 of a first store and one or more second terminals 120 of a second store.

The transaction system 118 manages checkout transactions across the terminals 120, integrating with the MLM 117 for item recognition and the picklist integration manager 115 for presenting item suggestions when needed. Transaction system 118 interacts with transaction managers 123 of terminals 120 to initiate, process, and complete transactions.

The transaction manager 123 on each terminal 120 coordinates between transaction processing through the transaction interface 124 and item training through the item training interface 126. The transaction manager 123 enables suspension of training sessions when transactions need to be processed and resumption of transactions when transaction manager 123 is idle and not performing transactions.

The transaction interface 124 provides the user interface for processing customer transactions, including integration of item images and descriptions from the picklist integration manager 115. Transaction manager 123 controls screen interfaces presented within the transaction interface 124 based on transaction states of transactions being processed.

The training session manager 125 manages the item training workflow on each terminal 120, coordinating with the cloud-based item training session manager 114 to track progress and maintain session state during item training sessions. Training session manager 125 enables the item training interface 126 to suspend a given item training session and resume an incomplete item training session. Training session manager 125 controls screen interfaces presented within the item training interface 126 based on training states for the item training sessions.

The item training interface 126 provides visual guidance for capturing item images, including indicators for proper item placement and automated image capture when items are properly positioned and no hands are detected in the camera field of view. The item training interface 126 supports suspending and resuming training sessions through the training session manager 125. The item training interface 126 automatically captures images when motion stops in the camera field of view and no hands are detected, improving efficiency and consistency of the training data collection process. Visual indicators show when proper positioning is achieved and the automated capture will occur.

FIG. 1B is a flow diagram of a method 100-1 for operating the system of FIG. 1A, according to an embodiment. FIG. 1B illustrates operational relationships between components of system 100.

The method 100-1 begins with capturing item training images on a terminal using the item training interface (100-1-1). The captured images are stored within the cloud or server (100-1-2). The stored images are used in two parallel paths: training the vision-based item recognition MLM (100-1-3A) and integrating item descriptions and images into the transaction interface (100-1-3B). The MLM training enables item recognition during self-service transactions (100-1-4). The item descriptions and images are integrated into a UPC item description and image list (100-1-5) and integrated into picklist buttons within the transaction interface 124 during self-service transactions (100-1-6).

FIG. 1C is a diagram of a terminal display 100-2 and the screen 100-2-1 for an item training interface, according to an example embodiment. FIG. 1C illustrates an initial screen 100-2-1 of the item training interface 126. The screen 100-2-1 includes input fields 100-2-3 for product description and an item barcode, which is populated using the shared barcode scanning service 113. A grid display 100-2-2 shows nine distinct regions where item images need to be captured, with each region displaying visual indicators showing completion status and remaining required item positions or orientations. An exit option (100-2-4) allows the attendant to suspend the training session and revert back to transaction interface 124 for transaction processing on terminal 120.

FIG. 1D is a diagram of the terminal display 100-3 and another screen 100-3-1 for the item training interface 126, according to an example embodiment. The screen 100-3-1 includes input fields 100-3-5 for a current product or item 100-3-3 description and barcode, which is populated using the shared barcode scanning service 113. A grid display 100-3-2 shows nine distinct regions where item images need to be captured. In the example illustrated the item 100-3-3 is depicted in the uppermost top left region. An exit option 100-3-4 allows the attendant to suspend the training session and revert back to transaction interface 124 for transaction processing on terminal 120.

The regions map to and correspond with physical locations or positions on the terminal countertop. The “7” depicted in each grid cell indicates the remaining number of different positions of item 100-3-3 that still need to be captured within each region. That is, in order for training on an item to be completed, the item needs to be placed in 7 different positions or orientations within each grid cell. Item 100-3-3 is shown in one example position of 7 positions within the first grid cell of 9 grid cells.

In an embodiment, the number of product or item positions and orientations within each grid cell is configurable. In an embodiment, the number of grid cells for the terminal countertop is configurable.

Screen 100-3-1 also illustrates selectable interface options including a save option 100-3-6 to save the item training session for item 100-3-3, a reset cell 100-3-7 to erase or remove the image captured for the item 100-3-3 in grid cell 1 in the illustrated orientation, and a return option 100-3-8 for the attendant to move back to a prior screen.

Detailed training instructions are provided in a rendered and populated product instructions field or area 100-3-9. This permits the attendant to have detailed instructions on how to orient the product within each grid cell or region on the terminal countertop. The placement instructions 100-3-9 interactively guide the attendant through proper item positioning and orientation within each region of the terminal countertop.

The placement instructions 100-3-9 are dynamically updated based on the current capture region and position requirements. As the attendant completes image captures for each position, the instructions automatically update to guide proper item placement for the next required position or region.

In an embodiment, screen 100-3-1 also includes a timer display and progress indicator that tracks the overall progress of the item training session. The timer helps attendants manage time spent on training activities during idle periods between transactions.

In an embodiment, the grid display 100-3-2 shows completion status for each region and position using visual indicators. The “7” displayed in each grid cell indicates the remaining positions needed for that region rather than the total required positions. As images are captured successfully, the count decrements to show progress.

Collectively, 100-3-6, 100-3-7, 100-3-8, and 100-3-9 are shown under and within a sub screen associated with populated product name and scanned barcode 100-3-5. Notably, the arrangement of the training interface elements within screen 100-3-1 is configurable.

FIG. 1E is a diagram illustrating use 100-4 of an item stabilizing widget 100-4-1 with an item 100-4-2 during item image capture of an item training session, according to an example embodiment. The widget 100-4-1 prevents items, particularly cylindrical or unstable items, from moving during image capture. The widget 100-4-1 is positioned on the terminal countertop to provide stable support while remaining outside the camera field of view for the captured images.

The widget 100-4-1 includes a wedge-shaped design that prevents cylindrical items like bottles from rolling during image capture. The widget 100-4-1 is designed to stabilize items while maintaining proper positioning for consistent image capture across different angles and orientations. The widget's specific shape and dimensions ensure it remains outside the camera's field of view during image capture while still providing sufficient support surface area to stabilize items on the terminal countertop.

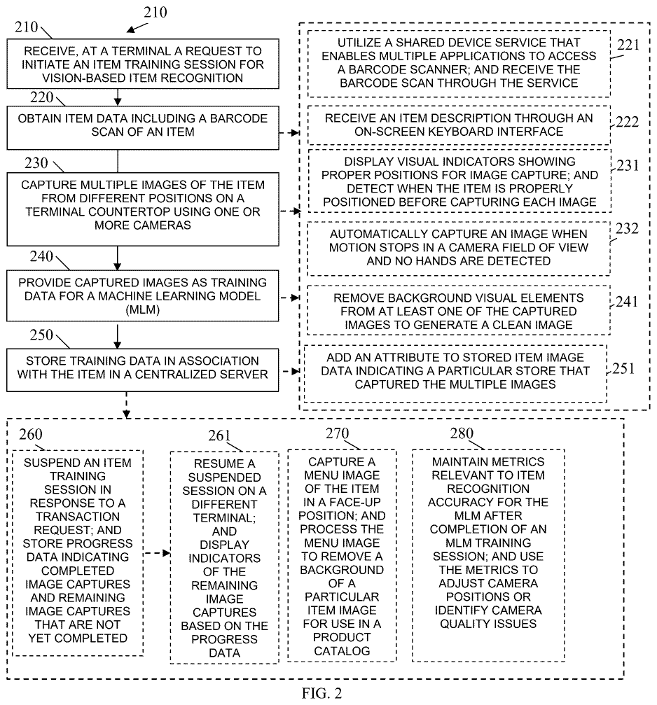

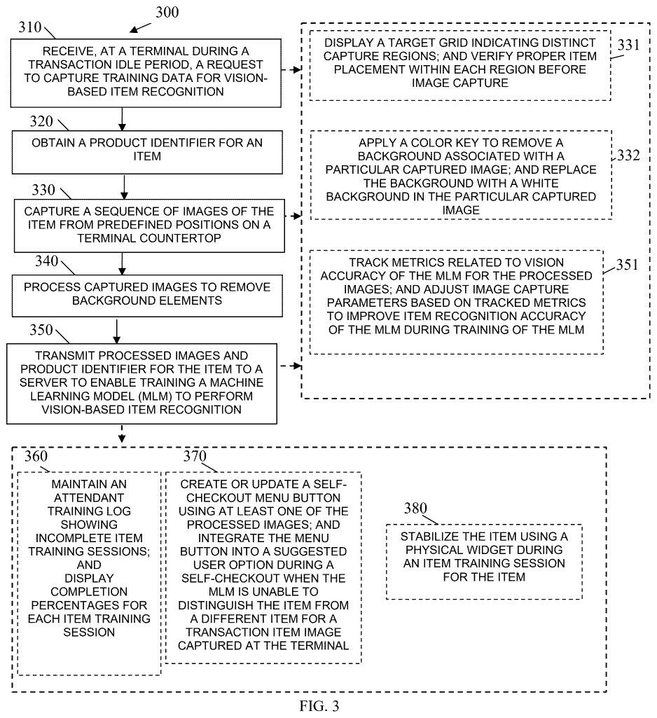

Having described the components and interfaces of system 100, attention is now directed to methods 200 and 300 that detail specific processes for distributed item training for vision-based item recognition according to various embodiments. The embodiments discussed above and other embodiments are presented with the discussions of FIGS. 2-3 and methods 200 and 300.

FIG. 2 is a flow diagram of a method 200 for distributed item training for vision-based item recognition, according to an example embodiment. The software module(s) that implements the method 200 is referred to as a “distributed item recognition trainer.” The distributed item recognition trainer is implemented as executable instructions programmed and residing within memory and/or a non-transitory computer-readable (processor-readable) storage medium and executed by one or more processors of one or more devices. The processor(s) of the device that executes the distributed item recognition trainer are specifically configured and programmed to process the distributed item recognition trainer. The distributed item recognition trainer may have access to one or more network connections and the connections may be wired, wireless, or a combination of wired and wireless.

In an embodiment, the device that distributed item recognition trainer is terminal 120. In an embodiment, terminal 120 is a POS terminal or an SST. In an embodiment, cloud 110 and terminal 120 execute the distributed item recognition trainer. In an embodiment, the distributed item recognition trainer is all or some combination of 113-118 and/or 123-126.

At 210, distributed item recognition trainer receives, at a terminal, a request to initiate an item training session for vision-based item recognition. The terminal 120 includes an option within its transaction interface 124 to transaction to an item training interface 126. Selection of the option by an attendant causes transaction manager 123 to provide control to training session manager 125 for an item training session.

At 220, the distributed item recognition trainer obtains item data include a barcode scan of an item. In an embodiment, at 221, the distributed item recognition trainer utilizes a shared device service (e.g., shared barcode scanning service 113) that enables multiple applications to access a barcode scanner and receive the barcode scant through the shared device service. In an embodiment, at 222, the distributed item recognition trainer receives an item description through an on-screen keyboard interface of the terminal 120.

At 230, the distributed item recognition trainer captures multiple images of the item from different positions and/or item orientations on a terminal countertop using one or more cameras interfaced to or integrated within terminal 120. In an embodiment, at 231, the distributed item recognition trainer displays visual indicators showing proper positions for image capture. Further, distributed item recognition trainer detects when the item is properly positioned before capturing each item image. In an embodiment, at 232, the distributed item recognition trainer automatically captures an item image when motion stops in a camera field of view and no hands are detected within the field of view.

In an embodiment, at 240, the distributed item recognition trainer provides captured item images as training data for an MLM 117. In an embodiment, at 241, the distributed item recognition trainer removes background visual elements from at least one of the captured images to generate a clean image for use in an item or product catalog.

At 250, the distributed item recognition trainer stores the training data in association with the item in a centralized server or cloud 110. In an embodiment, at 251, the distributed item recognition trainer adds an attribute to stored item image data indicating that a particular store captured the multiple item images.

In an embodiment, at 260, the distributed item recognition trainer suspends an item training session in response to a transaction request. The distributed item recognition trainer stores progress data indicating completed image captures and remaining image captures that are not yet completed. In an embodiment of 260 and at 261, the distributed item recognition trainer resumes a suspended session on a different terminal 120 associated with a same attendant or a different attendant. The distributed item recognition trainer displays indicators of the remaining image captures based on the progress data.

In an embodiment, at 270, the distributed item recognition trainer captures a menu image of the item in a face-up position or orientation. The distributed item recognition trainer processes the menu image to remove a background of a particular item image for use in a product catalog.

In an embodiment, at 280, the distributed item recognition trainer maintains metrics relevant to item recognition accuracy for the MLM 117 after completion of an MLM training session. The distributed item recognition trainer uses the metrics to adjust camera positions or identify camera quality issues that may be affecting the item recognition accuracy of the MLM 117 for the item.

FIG. 3 is a flow diagram of another method 300 for distributed item training for vision-based item recognition, according to an example embodiment. The software module(s) that implements the method 300 is referred to as an “item recognition trainer.” The item recognition trainer is implemented as executable instructions programmed and residing within memory and/or a non-transitory computer-readable (processor-readable) storage medium and executed by one or more processors of a device. The processors that execute the item recognition trainer are specifically configured and programmed for processing item recognition trainer. The item recognition trainer may have access to one or more network during operation, the networks may be wired, wireless, or a combination of wired and wireless.

In an embodiment, the device that executes the item recognition trainer is terminal 120. In an embodiment, terminal 120 is a POS terminal and/or an SST. In an embodiment, cloud 110 and terminal 120 execute the item recognition trainer. In an embodiment, item recognition trainer is all or some combination of 113-118, 123-126, and/or method 200. The item recognition trainer presents another, and in some ways an enhanced processing perspective from that which was described above with method 200 of FIG. 2.

At 310, the item recognition trainer receives, at a terminal 120 during a transaction idle period, a request to capture training data for vision-based item recognition. The terminal may be a POS terminal or an SST terminal.

At 320, the item recognition trainer obtains a product identifier for an item. The product identifier is received through a barcode scan via item training interface 126.

At 330, the item recognition trainer captures a sequence of images of the item from predefined positions, regions, and/or item orientations on a terminal countertop. In an embodiment, at 331, the item recognition trainer displays a target grid indicating distinct capture regions and the item recognition trainer verifies proper item placement and/or orientation within each region before image capture. In an embodiment, at 332, the item recognition trainer applies a color key to remove a background associated with a particular captured image and the item recognition trainer replaces the background with a white background in the particular captured image.

At 340, the item recognition trainer processes captured images to remove background elements. That is, any pixels not associated with the item are removed from a captured image of the item.

At 350, the item recognition trainer transmits processed images and product identifier for the item to a cloud 110 or server to enable training an MLM 117 to perform vision-based item recognition. In an embodiment, at 351, the item recognition trainer tracks metrics related to vision accuracy of the MLM 117 for the processed images and the item recognition trainer adjusts image capture parameters based on tracked metrics to improve item image capture and thereby improve item recognition accuracy of the MLM 117 during training session with the MLM 117.

In an embodiment, at 360, the item recognition trainer maintains an attendant training log showing incomplete item training sessions. The item recognition trainer displays completion percentages for each item training session.

In an embodiment, at 370, the item recognition trainer creates or updates a self-checkout menu button using at least one of the processed images. The item recognition trainer causes integration of the menu button into a suggested user option during a self-checkout when the MLM 117 is unable to distinguish the item from a different item for a transaction item image captured at the terminal 120.

In an embodiment, at 380, the item recognition trainer ensures stabilization of the item using a physical widget 100-4-1 or wedge during an item training session for the item. That is, an attendant using the physical widget 100-4-1 stabilizes the item and the item recognition trainer determines that the item is stationary before image capture by camera associated with the terminal 120.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving, at a terminal, a request to initiate an item training session for vision-based item recognition;
obtaining item data including a barcode scan of an item;
capturing multiple images of the item from different positions on a terminal countertop using one or more cameras of the terminal;
providing captured images as training data for a machine learning model (MLM); and
storing the training data in association with the item data in a centralized server.

2. The method of claim 1, wherein obtaining the item data comprises:
utilizing a shared device service that enables multiple applications to access a barcode scanner; and
receiving the barcode scan through the shared device service.

3. The method of claim 1, wherein obtaining the item data comprises receiving an item description through an on-screen keyboard interface.

4. The method of claim 1, wherein capturing the multiple images comprises:
displaying visual indicators showing proper item placement positions for image capture; and
detecting when the item is properly positioned before capturing each image.

5. The method of claim 1, wherein capturing the multiple images comprises automatically capturing an image when motion stops in a camera field of view and no hands are detected.

6. The method of claim 1, wherein providing the captured images comprises removing background visual elements from at least one of the captured images to generate a clean product image for the item.

7. The method of claim 1, wherein storing the training data comprises adding an attribute to stored item image data indicating a particular store that captured the multiple images for the item.

8. The method of claim 1, further comprising:
suspending an item training session in response to a transaction request; and
storing progress data indicating completed image captures and remaining image captures that are not completed.

9. The method of claim 8, further comprising:
resuming a suspended item training session on a different terminal; and
displaying indicators of the remaining image captures based on the progress data.

10. The method of claim 1, further comprising:
capturing a menu image of the item in a face-up position; and
processing the menu image to remove a background of a particular item image for use in a product catalog.

11. The method of claim 1, further comprising:
maintaining metrics relevant to item recognition accuracy for the MLM after completion of an MLM item training session; and
using the metrics to adjust camera positions or identify camera quality issues.

12. A method, comprising:
receiving, at a terminal during a transaction idle period, a request to capture training data for vision-based item recognition;
obtaining a product identifier for an item;
capturing a sequence of images of the item from predefined positions on a terminal countertop;
processing captured images to remove background elements; and
transmitting processed images and product identifier for the item to a server to enable training a machine learning model (MLM) to perform vision-based item recognition for the item.

13. The method of claim 12, wherein capturing the sequence of images comprises:
displaying a target grid indicating distinct capture regions; and
verifying proper item placement within each region before image capture.

14. The method of claim 12, wherein capturing the sequence of images comprises:
applying a color key to remove a background associated with a particular captured image; and
replacing the background with a white background in the particular captured image.

15. The method of claim 12, wherein transmitting the processed images comprises:
tracking metrics related to vision recognition accuracy of the MLM for the processed images; and
adjusting image capture parameters based on tracked metrics to improve recognition accuracy of the MLM during training of the MLM.

16. The method of claim 12, further comprising:
maintaining an attendant training log showing incomplete item training sessions; and
displaying completion percentages for each item training session.

17. The method of claim 12, further comprising:
creating or updating a self-checkout menu button using at least one of the processed images; and
integrating the self-checkout menu button into a suggested user option during a self-checkout when the MLM is unable to distinguish between the item and a different item from a transaction item image captured at the terminal.

18. The method of claim 12, further comprising, stabilizing the item using a physical widget during an item training session for the item.

19. A system, comprising:
one or more cameras;
a barcode scanner;
a display;
a processor configured to:
receive one or more requests to initiate one or more item training sessions during idle periods of one or more terminals;
capture multiple images of one or more items from different positions of one or more terminal countertops using the one or more cameras; and
process captured images to generate training data; and
a centralized server configured to:
receive training data from the one or more terminals; and
aggregate the training data per item to train a machine learning model (MLM) for vision-based item recognition.

20. The system of claim 19, wherein each terminal further comprises:
a stabilizing widget configured to prevent item movement during image capture;
wherein the processor is further configured to:
detect proper item stability on a corresponding terminal countertop based on use of the stabilizing widget before capturing at least one item image.
